(19) United States
(12) Patent Application Publication
(10) Pub. No.: US 2010/0048134 A1
(43) Pub. Date: Feb. 25, 2010

(54) WIRELESS COMMUNICATION SYSTEM AND COMMUNICATION METHOD WITH WIRELESS HEADSET

(76) Inventors: Randall T. McCarthy, Las Vegas, NV (US); Jong H. Kim, West Covina, CA (US)

Correspondence Address: LAW OFFICES OF LARRY K. ROBERTS, INC., 2 Park Plaza, Suite 300, Irvine, CA, 92614, US

(21) Appl. No.: 12/543,316

(22) Filed: Aug. 18, 2009

Related U.S. Application Data
(60) Provisional application No. 61/090,144, filed on Aug. 19, 2008.

(51) Int. Cl. H04B 7/00; H04B 1/38

(52) U.S. Cl. 455/41.3; 455/90.2

(57) ABSTRACT

An exemplary embodiment of a wireless headset system is described, and includes a headset equipped with a speaker system and microphone, and wireless communication capability using a wireless module such as a Bluetooth™ module. A wireless adapter or dongle is configured for pairing with the wireless headset, to provide a wireless audio communication link between the headset and the dongle. The dongle is configured to provide an analog audio signal to a utilization device, such as an analog signal multiplexer, such as an intercom unit. In an exemplary embodiment of a communication system and method, a plurality of the paired headsets and dongles are employed, with the multiplexer providing a composite analog signal of audio traffic from a plurality of the headsets to be transmitted from the plurality of dongles. In an exemplary embodiment, full duplex operation between the plurality of headsets may be provided.

### CROSS-REFERENCE TO RELATED APPLICATION

This application claims the benefit of U.S. Provisional Application No. 61/090,144 filed Aug. 19, 2008, the entire contents of which are hereby incorporated by reference.

### BACKGROUND

Wireless communication systems are utilized in many different applications. Such systems may use radio frequency signals to communicate with each other, such as “walkie-talkies.” Such devices are typically “push-to-talk” systems not capable of duplex operation. Other wireless systems have relatively short range.

### BRIEF DESCRIPTION OF THE DRAWINGS

FIG. 1A is a simplified schematic block diagram of an exemplary embodiment of a wireless communication system including a base station and a plurality of exemplary wireless headsets. FIG. 1B depicts a back panel of an exemplary embodiment of an intercom system for a base station.

FIGS. 2A, 2B and 2C are respective front, left and right views of an exemplary wireless headset.

FIG. 3A is a top view illustrating features of an exemplary embodiment of a portable dongle for use with a wireless communication system. FIG. 3B illustrates the dongle with a cable for charging the battery of the dongle.

FIGS. 4A, 4B and 4C are respective front, top and back views of an exemplary embodiment of a permanent mount dongle, for use with a wireless communication system.

FIG. 5 is a simplified schematic block diagram of an exemplary embodiment of a wireless headset.

FIG. 6 is a simplified schematic block diagram of an exemplary embodiment of a wireless dongle.

### DETAILED DESCRIPTION

In the following detailed description and in the several figures of the drawing, like elements are identified with like reference numerals. The figures are not to scale, and relative feature sizes may be exaggerated for illustrative purposes.

A wireless headset system is described, and includes a headset equipped with a speaker system and microphone, and wireless communication capability using a wireless module such as a Bluetooth™ module, and an antenna. The system further includes a wireless adapter or dongle configured for pairing with the wireless headset, to provide a wireless audio communication link between the headset and the dongle. The dongle includes a wireless module such as a Bluetooth™ module. The dongle is configured to provide an audio signal to a utilization device, such as an intercom.

A wireless communication system is also described. An exemplary embodiment of the system uses Bluetooth™ technology to provide wireless communication, and includes a base station and one or more headsets. The base system includes an intercom and a plurality of dongles, one each for pairing with a corresponding headset. A feature of an exemplary embodiment is that more than two persons can communicate in full duplex mode in wireless communication using Bluetooth™ technology.

The Bluetooth™ technology typically allow only one to one communication for audio applications, e.g. for a wireless headset and a cell phone. In an exemplary embodiment, to allow multiple persons (more than two persons) to have communications in a full duplex mode, an analog intercom is employed as a multiplexer. The analog intercom combines each individual Bluetooth™ connection and provides sharing the audio communication with each other. In this way, more than two persons may communicate in full duplex mode using the wireless communication system.

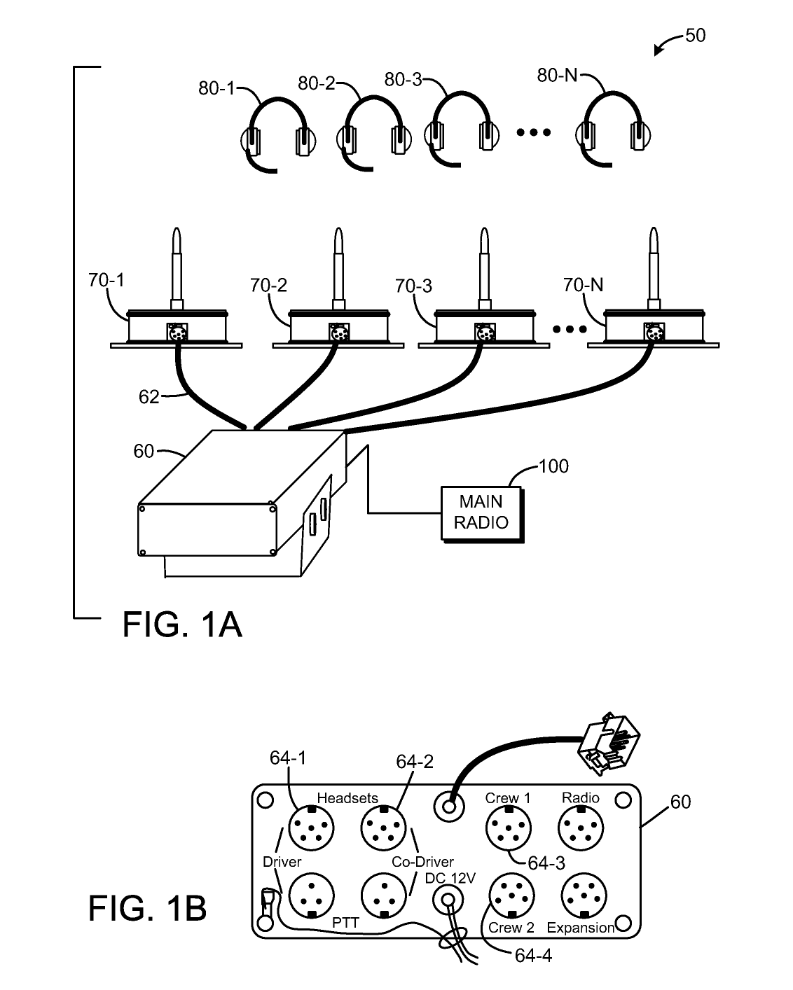

FIG. 1A schematically illustrates an exemplary wireless communication system 50. The system includes a base station including an intercom 60 connected by cables 62 to a plurality of wireless Bluetooth™ dongles 70-1, 70-2, 70-3 . . . 70-N. The system further includes a plurality of wireless headsets 80-1, 80-2, 80-3 . . . 80-N. The headsets are each configured for Bluetooth™ wireless operation. In an exemplary embodiment, the headset may also be configured for radio operation using an RF frequency band assigned to wireless communication.

The intercom 60 may be an analog intercom unit such as the model AR550 intercom available from the assignee of this application, AVCOMM International, Inc., and as described at http://www.avcomm.com/PDF/AR550.pdf, and at http://www.avcomm.com/PDF/AR550%20installation %20guide.pdf, the entire contents of which are incorporated herein by this reference. Instead of being connected directly by cables to wired headsets, as in the typical application for the AR550 intercom unit, the intercom unit 60 may be connected to each dongle by a cord 62, e.g. with 5-pin connectors. FIG. 1B depicts a back panel of an exemplary embodiment of intercom 60, corresponding to the AR550 intercom unit, with the dongles being connected to respective ones of the 5-pin universal connectors 64-1 (Driver), 64-2 (Co-Driver), 64-3 (Crew 1) and 64-4 (Crew 2). Other intercom units may alternatively be used, e.g. commercially available units marketed by David Clark, Sigtronics, and Firecom, using an appropriate interface cable.

The wireless headsets and the dongles are configured for Bluetooth™ pairing of a corresponding headset/dongle for operation. In an exemplary embodiment, the dongles and headsets are configured for the following exemplary Bluetooth wireless transmission parameters:
Bluetooth Transmission: Class 1
Bluetooth version: 2.0
Range: 300 Ft typical (free space)
Frequency: 2.400-2.485 GHz
Max Transmit Power +6 dBm
Min Transmit Power −27 dBm
Receive Sensitivity Better than −86 dB

The wireless headset is configured to process the analog signals generated by the microphone transducer, to upconvert digitized corresponding signals into wireless signals conforming to the Bluetooth™ protocols and for a paired dongle in the wireless communication system. The wireless headset is further configured to receive wireless signals conforming to the Bluetooth™ protocols at the headset and transmitted by a paired dongle in the system, downconvert the received signals to analog baseband form, and use the analog signals to drive the speakers in the ear modules of the headset.

Correspondingly, each dongle in the system is configured to upconvert the mixed analog signals provided by the intercom to upconverted digitized corresponding wireless signals conforming to the Bluetooth™ protocols for transmission to a paired wireless headset in the wireless communication system. The dongle is further configured to receive wireless signals conforming to the Bluetooth™ protocols at the dongle and transmitted by a paired headset in the system, and downconvert the received wireless signals to analog signals, which are passed to the intercom 60.

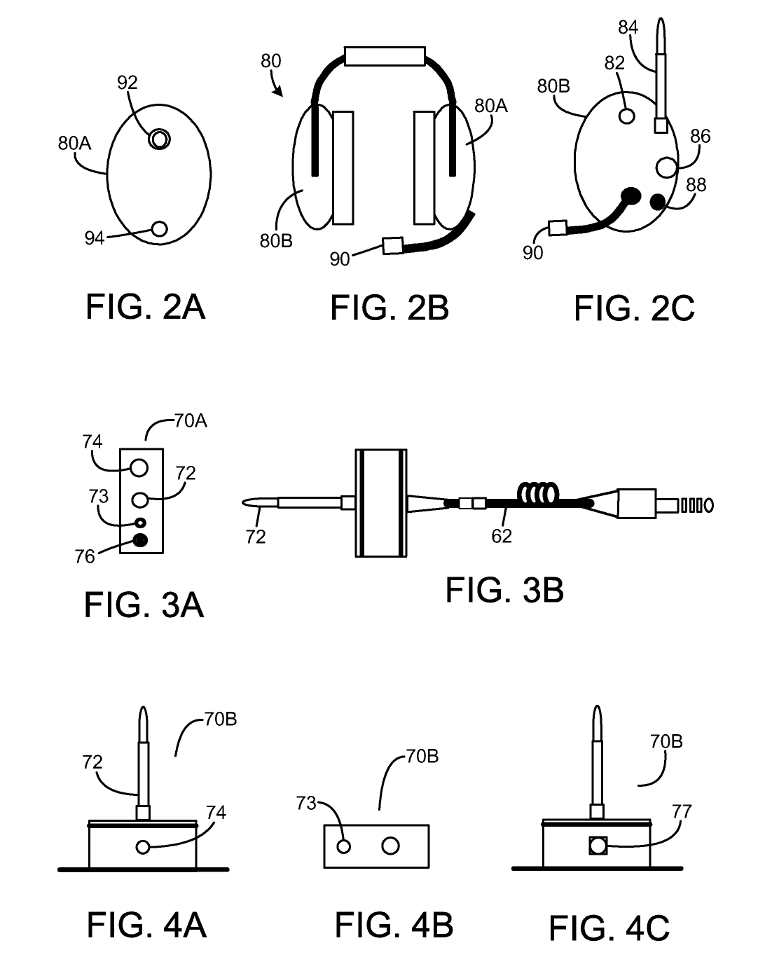

An exemplary embodiment of a headset 80 is depicted in FIGS. 2A, 2B and 2C. The headset includes left and right ear modules 80A, 80B, each of which may include an audio speaker or transducer. The housing of the module 80B has mounted therein a dual color LED (green and yellow), to function as power, connection charge and pairing status indicators. An antenna 84 is configured for receive/transmit operation, and is connected to a circuit module within the housing of module 80B. Also mounted to the housing of module 80B is a volume control 86, a power on/off switch 88 and a boom microphone 90. The module 80A may have a push-to-talk (PTT) switch 92 mounted on the housing, and a recharge port for connecting the head set to a battery charger, e.g. a 4.2 V charger to charge a battery mounted within headset ear module 80A. Cabling (not shown) electrically connects the ear modules 80A, 80B.

The headset 80 includes a Bluetooth™ circuit module to provide wireless communication using Bluetooth™ signal protocols. A controller mounted on a circuit board in the headset interfaces with the switches and Bluetooth™ circuit module to control operation of the headset. The controller may include a microcontroller programmed to perform the power up/down, timer, auto-reconnect, battery level and pairing functions, and to control the Bluetooth™ module. Alternatively, the program functions may be achieved by discrete logic circuitry.

The Bluetooth™ dongles 70-1, 70-2, 70-3 . . . 70-N may be configured for permanent mounting with connection to a separate power source, or for portable mounting using rechargeable battery power. Features of an exemplary embodiment of a wireless dongle may include the following:
a) rugged aluminum extrusion design;
b) wide power supply range: 7˜25V;
c) DNR® to reduce noise;
d) easy pairing process;
e) RP-SMA antenna connector for easy antenna connection;
f) mini XLR connector for universal interface for most intercom systems, e.g. fire engine intercom systems.

The dongles each include an antenna, connected to a Bluetooth™ circuit module, with a controller circuit to control operation of the dongle. The controller circuit may include a microcontroller programmed to perform the power up/down, timer, auto-reconnect, and pairing functions, and to control the Bluetooth™ circuit module. Alternatively, the program functions may be achieved by discrete logic circuitry.

An exemplary embodiment of the wireless headset 80 may include the following features:
a) rugged design for industrial professional applications;
b) comfort gel ear seal;
c) splash proof (will work in raining environment);
d) auto power shut off with inactive application;
e) easy pairing process;
f) auto reconnect when the unit is in the range;
g) battery life: 24 hours;
h) battery charging time: 3 hours;
i) dual color LED for battery level and connection state;
j) tone alert for low battery and battery state;
k) replaceable Li-Ion battery;
l) either over the head and behind the head applications.

In an exemplary embodiment of a wireless communication system, the headset may have a PTT (Push To Talk) switch 92 to trigger a radio 100 (FIG. 1A) at the base station. The PTT switch generates a digital (high/low state) signal, which is detected at the intercom and radio to trigger radio operation, which may have longer range than the Bluetooth™ mode. Thus, with this optional feature, the wireless communication system may have two operating modes, a radio mode and a Bluetooth™ mode. The digitized signal for the PTT is configured by the Bluetooth module. The Bluetooth™ module of the dongle decodes the digital PTT signal. In an exemplary embodiment, the intercom unit such as the AR550 intercom unit has a PTT function which is activated when the intercom unit detects the decoded high/low PTT signal. Thus, in the radio mode, the wireless headset may communicate through the paired dongle with another party using a radio set such as a two-way radio, which may be located much farther away from the base station than the party using the wireless headset. The PTT switch at the headset enables the headset user to transmit, and when the switch is released, the headset user may listen to the radio user's transmissions.

The analog intercom 60 functions as a multiplexer, and mixes all audio traffic of the plurality of headsets, i.e. by mixing the audio signals provided by the respective dongles to provide a combined or composite analog audio signal. The combined analog audio signal is assigned to each of the dongles for transmission to the headsets.

The dongles can be configured for portable mounting, with rechargeable power supplies or batteries, or configured for permanent mounting, in which the dongles are connected to an external power source. FIGS. 3A-3B illustrate a dongle 70A configured for portable mounting, and includes an antenna 72, an LED 73 which may be a dual color yellow/green LED, a pairing switch 74, and a power port 76 for connection to a battery charger. The dongle is connected to the intercom 60 by a cable 78 connected to a port 77 on the dongle housing.

Each dongle is paired with a corresponding wireless headset. Pairing is needed only once when the units need to be paired. An exemplary pairing procedure for a portable dongle 70A with rechargeable battery is described below:

1. Connect the dongle to an active intercom system.

2. Turn the headset off.

3. Push pairing Button for 3 seconds. The yellow and green LED 73 on the dongle will blink alternately.

4. Press PWR button on the headset for 8 seconds until the LED changes to yellow.

5. The headset and dongle will auto-connect after the pairing is initiated.

A dongle 70B configured for permanent mounting is depicted in FIGS. 4A, 4B and 4C. The dongle 70B includes an antenna 72, and a pairing switch 74, as with the portable dongle. A connector port 77 is provided for connecting the dongle to the intercom. The dongle is configured for pairing with a corresponding headset. Pairing is needed only once when the units need to be paired. An exemplary pairing procedure for the permanent mount dongle is as follows:

1. Connect the dongle to an active intercom system and check that the LED 73 on the dongle is green.

2. Turn the headset off.

3. Use a small screw driver or pin and push the pairing switch on the dongle for 3 seconds. The yellow and green LED 73 on the dongle will blink alternately.

4. Press PWR button on the headset for 8 seconds until the LED changes to Yellow.

5. The headset and dongle will auto-connect after the pairing is initiated.

Among the aspects of the wireless communication system described herein includes the use of a multiplexer to allow multiple persons (more than two persons) to have wireless communication in full duplex mode. In an exemplary embodiment, an analog intercom may be used as a multiplexer, to combine each individual Bluetooth™ connection and allow each connection to share the audio signals of the other connections.

Another feature of the wireless communication system is the use of a PTT control signal generated by the Bluetooth™ technology on the headsets. The headset will not only process audio signals but also send a PTT digital (high/low state) control signal for triggering a radio 100 at the base station. The particular headset which generated the PTT control signal then communicates through the radio 100 at the base station and other two-way radio users within radio range of the radio 100 may receive the voice transmission from the headset user. The headset user may receive the voice transmission from the radio user, from the radio 100, intercom 60 and dongle 70.

Other features of the wireless communication system include the headset and dongle circuit or microcomputer programming to provide power up/down, timer, auto-reconnect, battery level, easy and reliable pairing, and control of the Bluetooth™ circuit modules in each headset and dongle. One exemplary operation is the following:

Power up/down: Press PWR button for 2 seconds.

Timer: Headset automatically shuts off after 5 minutes continuous disconnection.

Auto-reconnect: Headset automatically reconnects to the base when the headset had been out of range and returns in the range within 5 minutes.

Battery Level: LED blinking and Tone alert.

Easy and Reliable Pairing: Press pairing button for 8 seconds.

Controlling Bluetooth Modules: Auto programming at power on.

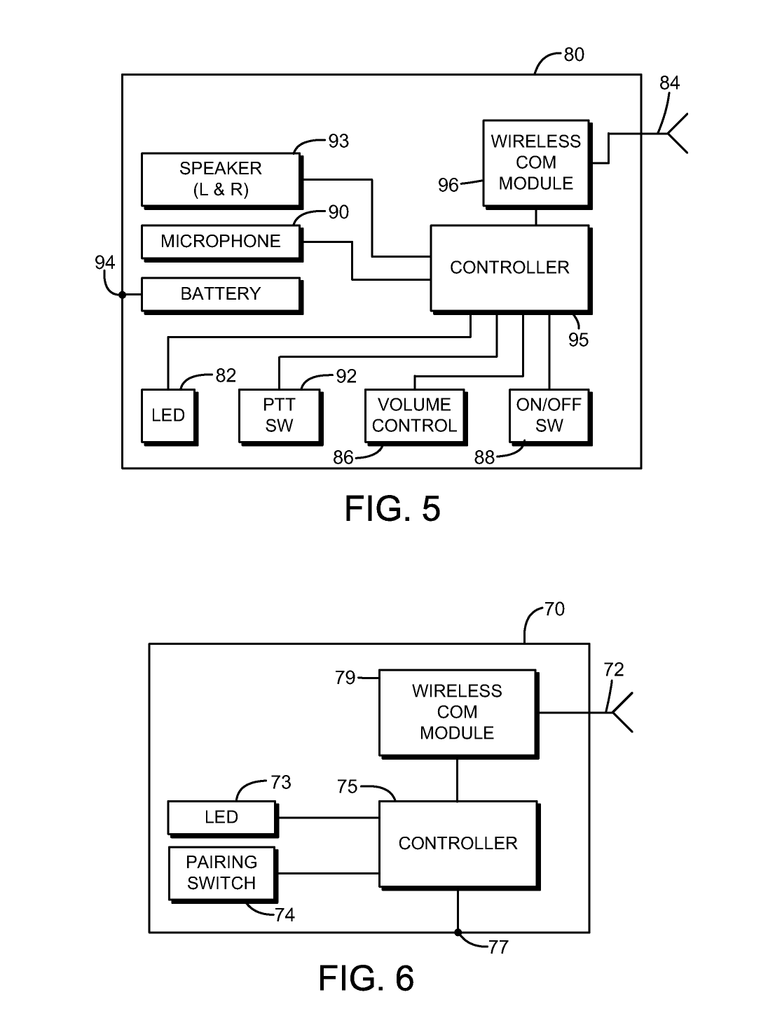

FIG. 5 is a simplified schematic block diagram of an exemplary embodiment of a wireless headset 80. As shown, the headset includes a microprocessor or microcomputer-based controller circuit 95, which may also include the amplifier and driver circuits for the microphone 90, speaker(s) 93 and LED 82. The headset includes a rechargeable battery 94 as the power source, with the volume control 86 providing gain control and the on/off switch used to turn the headset circuits on/off. The controller circuit is coupled to the wireless communication module 96, a Bluetooth™ circuit module. Bluetooth™ circuit modules suitable for the purpose are commercially available. The module 96 is coupled to the headset antenna 84 for wireless transmission and reception. The controller provides and receives audio signals to be transmitted or which have been received via module 96.

FIG. 6 is a simplified schematic block diagram of an exemplary embodiment of a wireless dongle 70. The dongle includes a microprocessor or microcomputer-based controller 75, which is connected to a Bluetooth™ circuit module 79. Bluetooth™ circuit modules suitable for the purpose are commercially available. The dongle power source is omitted from FIG. 5 for simplicity, but may include a battery or a connection to a power supply. The LED 73 is driven by the controller 75. The controller 75 is connected to port 77, a connector configured for connection to a utilization device such as intercom 60. The controller 75 provides and receives audio signals to be upconverted and transmitted through the module 79 and antenna 72, or which are received from the module 79 and antenna 72. In an exemplary embodiment the connector 77 is a 5-pin universal connector, in which a first pair of pins is assigned to carry audio input signals, a second pair of pins is assigned to carry audio output signals and the fifth pin is assigned to carry the PTT signal.

In another exemplary embodiment, a dongle 70 may be connected directly to a two-way radio such as radio 100 (FIG. 1), i.e. without using the multiplexing capability of an intercom unit. An appropriate interface cable may be used to connect the dongle, with its 5-pin connector, to the radio. In such an application, a wireless headset 80 paired to the dongle 70 may communicate with a two-way radio user, using the PTT switch on the headset to set the radio to transmit mode. Release of the headset PTT switch puts the radio, through the paired dongle in a receive mode, to receive voice transmissions from a two-way radio user.

Exemplary embodiments of the wireless communication system may be used in different applications, including railroads, fire/public safety, military, racing, agriculture, heavy industry and aviation, particularly ground crew.

Although the foregoing has been a description and illustration of specific embodiments of the subject matter, various modifications and changes thereto can be made by persons skilled in the art without departing from the scope and spirit of the invention.

What is claimed is:

1. A wireless communication system, comprising:
a base station including an analog multiplexer unit which receives analog input audio signals from a plurality of analog signal sources and outputs analog output audio signals, and a plurality of digital wireless protocol dongles connected to the multiplexer unit to provide said plurality of analog signal sources;
a plurality of wireless headsets, each headset equipped with a speaker system, a microphone, and a wireless communication system comprising a digital wireless module and an antenna;
wherein the wireless module of each of the plurality of headsets is configured to pair with a corresponding one of the wireless dongles connected to the multiplexer unit;
each of said plurality of wireless headsets is configured to process analog signals generated by the microphone, to upconvert digitized corresponding signals into wireless signals conforming to the digital wireless protocol, and to receive digital wireless signals conforming to the digital wireless protocol at the headset and transmitted by a paired dongle in the system, downconvert the received signals to analog baseband form, and use the analog signals to drive the speaker system of the headset;
each dongle in the system is configured to upconvert the analog output audio signals provided by the multiplexer unit to upconverted digitized corresponding wireless signals conforming to a digital wireless protocol for transmission to a paired wireless headset in the wireless communication system, and wherein each dongle is further configured to receive wireless signals conforming to the digital wireless protocol at the dongle and transmitted by a paired headset in the system, and downconvert the received wireless signals to analog signals, which are passed to the multiplexer unit;
wherein the multiplexer mixes received audio traffic from the plurality of headsets, by mixing the analog audio signals provided by the respective dongles to provide a composite analog audio signal, which is assigned to each of the dongles for transmission to the plurality of wireless headsets.

2. The system of claim 1, wherein the wireless protocol is a Bluetooth™ wireless protocol.

3. The system of claim 2, wherein the Bluetooth™ wireless protocol includes Bluetooth™ transmission Class 1.

4. The system of claim 1, wherein the plurality of headsets includes a first headset, a second headset and a third headset, and wherein said plurality of dongles connected to the multiplexer unit includes a first dongle, a second dongle and a third dongle, and wherein more than two persons can communicate in full duplex mode using the wireless communication system.

5. The system of claim 1, wherein:
the multiplexer unit is an analog intercom unit;
the base station further comprises a two-way radio connected to the intercom unit;
at least one of said headsets is configured for a radio mode, and includes a control circuit, a user-operated push-to-talk (PTT) switch coupled to the control circuit, the control circuit connected to the wireless module and configured to generate and transmit an encoded PTT signal from the wireless module when the PTT switch is actuated;
the paired dongle connected to the intercom unit is configured to decode the PTT signal;
the intercom unit is configured to detect the PTT signal and place the system in a radio mode, so that incoming audio signals from said at least one headset are passed to the radio for radio transmission when the PTT switch is pushed.

6. The system of claim 5, wherein the decoded PTT signal has a high or a low state.

7. The system of claim 5, wherein the paired dongle to the at least one headset is connected to the intercom unit by a wiring connector in which a first pair of pins is assigned to carry analog audio input signals, a second pair of pins is assigned to carry analog audio output signals, and a fifth pin is assigned to carry said decoded PTT signal.

8. The system of claim 1, wherein one of said headsets is further configured for radio operation using an RF frequency band assigned to wireless communication.

9. A wireless communication system, comprising:
a base station including an analog multiplexer unit which is configured to receive analog input audio signals from a plurality of signal sources and outputs analog output audio signals, and a digital wireless protocol dongle connected to the multiplexer unit and comprising one of said signal sources;
a portable wireless headset, equipped with a speaker system, a microphone, and a wireless communication system comprising a digital wireless module and an antenna;
wherein the wireless module of said headset is configured to pair with said wireless dongle connected to the multiplexer unit;
said wireless headset configured to process analog signals generated by the microphone, to upconvert digitized corresponding signals into wireless signals conforming to the digital wireless protocol, and to receive digital wireless signals conforming to the digital wireless protocol at the headset and transmitted by said paired dongle, downconvert the received signals to analog baseband form, and use the analog signals to drive the speaker system of the headset;
said dongle configured to upconvert the analog output audio signals provided by the multiplexer to upconverted digitized corresponding wireless signals conforming to a digital wireless protocol for transmission to said paired wireless headset, said dongle further configured to receive wireless signals conforming to the digital wireless protocol at the dongle and transmitted by said paired headset, and downconvert the received wireless signals to analog signals, which are passed to the multiplexer unit.

10. The system of claim 9, wherein said multiplexer unit includes an analog intercom unit.

11. The system of claim 10, wherein:
the base station further comprises a two-way radio connected to the intercom unit, and said system is configured for a radio mode;
said wireless headset includes a control circuit, a user-operated push-to-talk (PTT) switch coupled to the control circuit, the control circuit connected to the wireless module and configured to generate and transmit an encoded PTT signal from the wireless module when the PTT switch is actuated;
the paired dongle connected to the intercom unit is configured to decode the PTT signal, the intercom unit is configured to detect the PTT signal and place the system in the radio mode, so that incoming audio signals from said headset are passed to the radio for radio transmission when the PTT switch is pushed.

12. The system of claim 11, wherein the decoded PTT signal has a high or a low state.

13. The system of claim 11, wherein the paired dongle is connected to the intercom unit by a wiring connector in which a first pair of pins is assigned to carry analog audio input signals, a second pair of pins is assigned to carry analog audio output signals, and a fifth pin is assigned to carry said decoded PTT signal.

14. The system of claim 9, wherein the wireless protocol is a Bluetooth™ wireless protocol.

15. The system of claim 14, wherein the Bluetooth™ wireless protocol includes Bluetooth™ transmission Class 1.

16. A wireless headset system, comprising:
a portable wireless headset, equipped with a speaker system, a microphone, and a wireless communication system comprising a digital wireless module and an antenna;
a digital wireless protocol dongle configured for pairing with the wireless headset, to provide a wireless audio communication link between the headset and the dongle employing said wireless protocol;
said wireless headset configured to process analog audio signals generated by the microphone, to upconvert digitized corresponding signals into wireless signals conforming to the digital wireless protocol, and to receive digital wireless signals conforming to the digital wireless protocol at the headset and transmitted by said paired dongle, downconvert the received signals to analog baseband form, and use the analog signals to drive the speaker system of the headset; and
the dongle is configured to provide a dongle output analog audio signal corresponding to said headset analog audio signal to an analog signal utilization device, and to receive a dongle input analog signal from the analog utilization device, upconvert said dongle input signal into wireless signals conforming to the digital wireless protocol and transmit the wireless signals for reception at the portable wireless headset.

17. The system of claim 16, wherein the dongle input analog signal from the signal utilization device is a composite audio signal from a plurality of communication sources.

18. The system of claim 17, wherein the utilization device is an analog intercom unit.

19. The system of claim 16 wherein the utilization device is a two-way radio, and said wireless headset includes a control circuit, a user-operated push-to-talk (PTT) switch coupled to the control circuit, the control circuit connected to the wireless module and configured to generate and transmit an encoded PTT signal from the wireless module when the PTT switch is actuated;
the paired dongle connected to the radio is configured to decode the PTT signal, the radio is configured to detect the PTT signal so that incoming audio signals from said headset are passed to the radio for radio transmission when the PTT switch is pushed.

20. The system of claim 16, wherein the wireless protocol is a Bluetooth™ wireless protocol.

21. The system of claim 20, wherein the Bluetooth™ wireless protocol includes Bluetooth™ transmission Class 1.

22. The system of claim 16, wherein the speaker system includes a left ear speaker and a right ear speaker.

23. A method for providing full duplex communication between a plurality of wireless headsets, comprising:
transmitting wireless digital protocol signals from at least one of the plurality of headsets corresponding to audio voice signals from the at least one headset;
receiving the wireless digital protocol signals at least one digital wireless protocol dongle connected to an analog multiplexer unit at a base station, a respective one of the at least one dongle paired to a respective one of the at least one wireless headset;
downconverting the received digital protocol signals at the at least one dongle into analog dongle output signals;
combining the analog dongle output signals from the at least one dongle to form a composite multiplexer analog signal coupled to the at least one dongle;
upconverting the composite multiplexer analog signal at the at least one dongle and transmitting wireless digital protocol signals from the at least one dongle corresponding to the composite multiplexer analog signal.

24. The method of claim 23, wherein said at least one wireless headset includes at least first, second and third headsets, and said at least one dongle includes at least first, second and third dongles.
